(19) United States
(12) Patent Application Publication
(10) Pub. No.: US 2007/0159948 A1
(43) Pub. Date: Jul. 12, 2007

(54) Threshold crossing timing recovery for high capacity optical disc systems

(75) Inventor: Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,759

(22) PCT Filed: Feb. 1, 2005
(86) PCT No.: PCT/IB05/50421

§ 371 Date: Aug. 7, 2006

(30) Foreign Application Priority Data
Feb. 12, 2004 (EP) 04100533.1

(51) Int. Cl. G11B 20/10

(52) U.S. Cl. 369/59.21; 369/53.35

(57) ABSTRACT

The invention relates to a method of providing timing error information in optical systems, especially for reading high capacity optical discs, i.e. optical discs with a capacity of about 27 GB or above. At these capacities current threshold crossing timing recovery does not perform well and even becomes unfeasible due to severe inter-symbol interference. The method suggests using an upper and/or lower secondary eye in the eye diagram of the data signal to acquire the timing error information. Hereby, threshold crossing timing recovery becomes feasible for high capacity optical systems, where the central eye is closed or nearly closed due to the inter-symbol interference.

### FIELD OF THE INVENTION

This invention relates to a method of providing threshold crossing timing recovery in an optical system, which optical system is adapted to read data samples from an optical disc, said method comprising the steps of reading data samples at a sampling time from the optical disc by means of the optical system; feeding the read data signal samples to a timing recovery means; determining timing error information by means of the timing recovery means; and adjusting the sampling time towards the synchronous timing instants on the basis of the timing error information.

### BACKGROUND OF THE INVENTION

Optical discs are electronic data storage mediums that hold information in digital form and that are written and read by a laser in an optical system. These discs include all the various CD (compact disc), DVD (Digital Versatile Disc) and BD (Blu-ray Disc) variations. Data are stored in so-called pits and lands (ROM disc) and marks and spaces (re-writable disc), which are read by means of a laser in an optical system and the data are converted into an electrical signal.

In an optical system it is well known to use a threshold crossing timing recovery in reading optical discs, so that the sampling time of the data signal read from the optical disc is adjusted by comparing the actual threshold crossings with threshold crossings of a sampling clock signal. This threshold crossing timing recovery acquires the timing information from the incoming data itself and needs no aid from the bit decision, so that it is not hampered by decision errors. A special case of threshold crossing timing recovery is the zero crossing timing recovery, where the threshold is set to zero; this is feasible for optical discs due to the DC free feature of the binary bit sequence recorded on the disc. The zero crossing timing recovery is the recovery scheme usually employed in current optical discs, i.e. optical discs with a capacity of about 27 GB or below, where the data thereon typically are coded in Run Length Limited (RLL) coding.

In timing recovery in an optical system, timing error information (ψₖ) is determined. This timing error information (ψₖ) will be zero in case of a noise free channel with for example a raised-cosine characteristic as the data signal samples are synchronously sampled. However, the optical system is subjected to noise and can have a partial-response like channel, which result in the fact that, with bit synchronous sampling, only the mean value of the timing error information (ψₖ) is zero, while it instantaneously is jittery. When the data on the disc are recorded in RLL coding, the zero crossing timing recovery suffers very weakly from data-induced jitter in a disc capacity of 27 GB or less. However, in optical discs with capacities above 27 GB the data-induced jitter becomes a more severe problem due to a smaller channel bit length.

Increasing the storage density on optical discs is a concern of great importance and attention. At present, it is known to try to reach higher storage densities by using more advanced signal processing, different modulation schemes (for instance multi-level techniques) or different physical principles (for instance super-resolution techniques), given the characteristics of the optical channel. However, as the disc capacity increases by means of narrowing the channel bit length, for example to 29 GB or above, the data samples around transitions (i.e. threshold crossings, e.g. zero crossings) cannot avoid Inter-Symbol Interference (ISI). The data-induced jitter gets so severe at disc capacities of 31 GB, due to the strong ISI, that traditional threshold crossing timing recovery becomes unfeasible.

### OBJECT AND SUMMARY OF THE INVENTION

It is the object of the invention to provide a method of providing threshold crossing timing recovery in an optical system, where the impact of data-induced jitter is alleviated, especially in the case of high capacity optical discs, i.e. optical discs with capacities of about 27 GB or above.

This object is achieved when the method of the opening paragraph is characterized in that an eye pattern of the data signal samples is used in the step of determining timing error information, and that the timing recovery means is adapted to extract timing error information at the position of a secondary eye in the eye pattern. Hereby, timing error information can be extracted from the data signal samples even though the central eye in the eye diagram is substantially closed, i.e. the data signal samples around zero crossings are extremely jittery. Threshold crossing timing recovery has the advantage of no need of data aid and is therefore not hampered by bit decision errors. By means of the method of the invention, timing recovery benefits from the advantage of threshold crossing timing recovery while the impact of data-induced jitter, especially in high and ultra high disc capacities, is overcome.

The term “eye pattern” is synonymous with “eye diagram”; such an eye pattern appears when a data signal is plotted on an oscilloscope that is synchronized to the data clock. This results in a signal cut into traces of one or more symbol intervals that are overlaid on the screen of the oscilloscope.

An eye pattern of a signal can contain one or more ‘eyes’, areas surrounded by overlaid signal waveforms, where the shape and size of the ‘eyes’ provide an indication of the margin of the system against various disturbances/noise. Thus, a minimal signal distortion corresponds to an eye pattern with almost ideal open eyes, and distortion of the signal waveform due to inter-symbol interference and noise intends to close the eyes in the eye pattern. Ideal sampling instants may be derived from the instants at which the eye crosses zero. A central eye is an eye in the eye pattern situated around 0/ the threshold (vertically) in the oscilloscope display; the term “secondary eye” is meant to cover an eye displaced vertically in relation to 0/the threshold in the oscilloscope display.

It should be noted, that extraction of timing error information at the position of a secondary eye in the eye pattern does not preclude the simultaneous or alternative extraction of timing error information in other ways, wherever appropriate.

The method according to the invention is preferably well-suited for timing recovery in reading data signal samples encoded in binary modulation and preferably Run Length Limited (RLL) coding, in that the use of RLL coding alleviate data-induced jitter to some extent. However, when the disc capacities of optical discs increase to above e.g. 30 GB, even RLL coding is not enough to ensure feasibility of traditional timing recovery, in that the eye pattern becomes closed. By the use of RLL-coding and the method of the invention, optical discs with disc capacities beyond 30 GB can be read with acceptable signal-to-noise-ratios.

Preferably, the timing recovery means used in the method according to the invention uses threshold crossing timing recovery, and preferably the threshold crossing timing recovery is zero crossing timing recovery. Threshold crossing timing recovery is the timing recovery scheme most commonly used in optical disc systems. It adjusts the sampling time in response to the times at which the data signal crosses a certain amplitude threshold. This scheme acquires the timing information from the incoming data itself and needs no aid from bit decisions; thus, it is not hampered by decision errors. In optical discs containing binary bit sequences being DC free, zero crossing timing recovery can be used as the threshold crossing timing recovery. Hereby, the timing error information can be derived simply.

In a preferred embodiment of the method according to the invention the timing error information (ψₘ) around a threshold crossing between the instants mT and (m+1)T is calculated as:

$${ψ}_{m} = \frac{{y}_{m} - x}{{y}_{m} - {y}_{m + 1}} - α T , \qquad ( 1 )$$

where T is the data sample period, yₘ and yₘ₊₁, respectively, is the data signal sample at the instants mT and (m+1)T, respectively, α is a phase shift constant lying in the interval 0≦α<1, and x is a displacement of the threshold.

In an alternative, preferred embodiment of the method according the invention, the timing error information (ψₘ) around a threshold crossing between the instants mT and (m+1)T is calculated as:

$${ψ}_{m} = \frac{{y}_{m} - {x}^{′}}{{y}_{m} - {y}_{m + 1}} - β T , \qquad ( 2 )$$

where T is the data sample period, yₘ and yₘ₊₁, respectively, is the data signal sample at the instants mT and (m+1)T, respectively, β is a phase shift constant lying in the interval 0≦β<1, and x′ is a displacement of the threshold.

The equations (1) and (2) provide two ways to calculate the timing error information (ψₘ) when the traditional acquisition thereof is not or hardly feasible. Thus, the acquisition of ψₘ includes a shifting of the threshold level up by x (equation (1)) or down by x′ (equation (2)) (in that x′ typically is negative).

### BRIEF DESCRIPTION OF THE DRAWINGS

The invention will be explained more fully below in connection with a preferred embodiment and with reference to the drawing, in which:

FIG. 1 is a schematic drawing of non-data-aided timing recovery;

FIG. 2 shows timing error detection in zero crossing timing recovery

FIG. 3a and 3b show eye patterns of Blu-ray discs with capacities 25 GB and 32 GB, respectively;

FIG. 4 illustrates threshold shifts in an eye pattern according to the invention; and

FIG. 5 shows jitter values measured at central eye and at secondary eye according to the invention.

### DESCRIPTION OF PREFERRED EMBODIMENTS

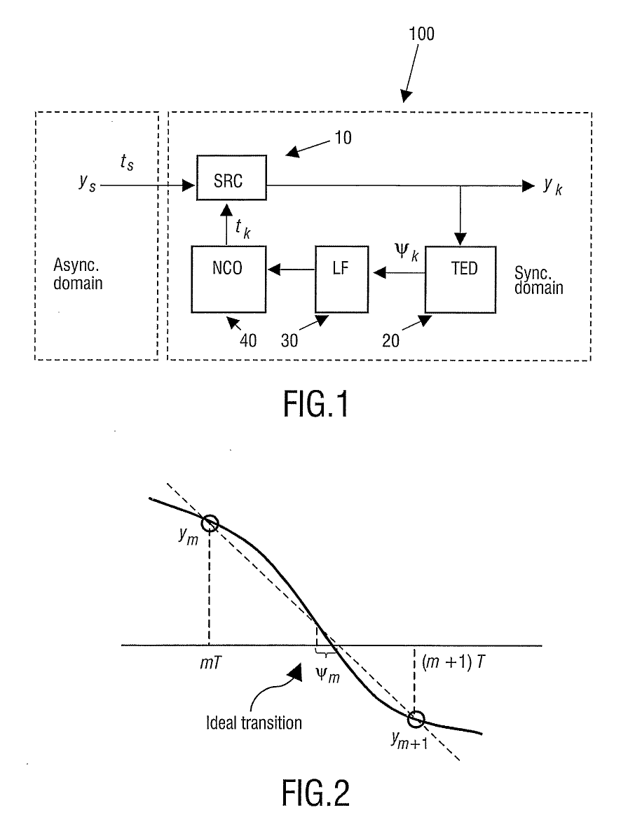

FIG. 1 is a schematic drawing of non-data-aided timing recovery. FIG. 1 shows a timing recovery means 100 with a sample rate converter SRC 10, a timing error detection means in the form of a timing error detector (TED) 20, a loop filter LF 30, and a numerically controlled oscillator (NCO) 40. The numerically controlled oscillator 40 outputs to the sample rate converter 10 the sampling clock tₖ that is updated on the basis of timing error information ψₖ detected by the timing error detector 20. The timing recovery means 100 is fed with non synchronized data samples yₛ from the asynchronous domain upstream of the timing recovery means 100, and bit decisions are made on the synchronized data samples yₖ in the synchronous domain downstream of the timing recovery means 100.

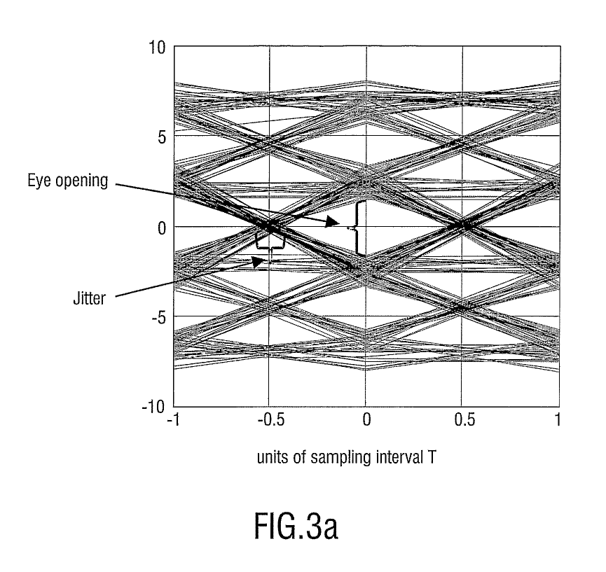

FIG. 2 shows timing error detection in threshold crossing timing recovery. The horizontal line indicates the threshold and the curve is the signal from the optical disc. In threshold crossing timing recovery of data signal samples recorded on an optical disc, the timing error information ψₖ can be derived to the first order of approximation as shown in FIG. 2. ψₖ can be expressed as:

$${ψ}_{k} = \frac{{y}_{k}}{{y}_{k} - {y}_{k - 1}} - \frac{T}{2} . \qquad ( 3 )$$

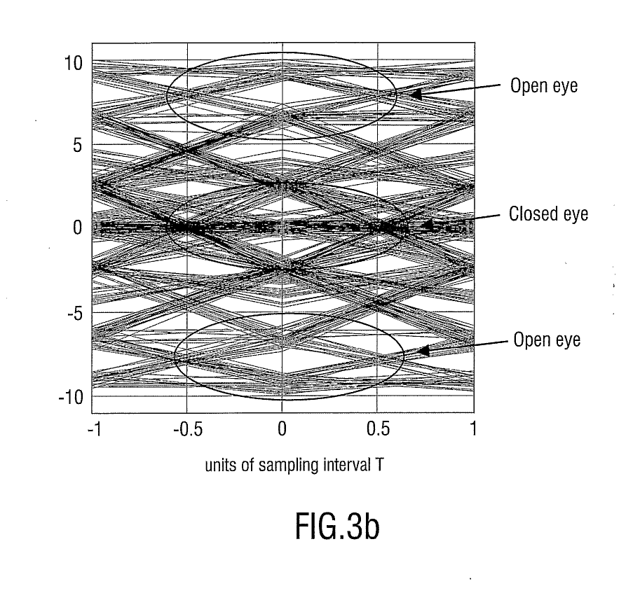

In the case of a noise-free channel with, for example, a raised-cosine characteristic, ψₖ will approach zero as the data signal is synchronously sampled. However, the optical channel is subject to different types of noise and normally of a partial-response type, which result in the fact that with bit synchronous sampling only the mean value of ψₖ is zero while it remains instantaneously jittery due to noise-induced jitter and data-induced (or pattern dependent) jitter. This is illustrated in FIGS. 3a and 3b, respectively, which show eye patterns of Blu-ray discs with capacities 25 GB and 32 GB, respectively. The examples in FIGS. 3a and 3b are calculated with the Braat-Hopkins model for a 25 GB and a 32 GB Blu-ray disc, respectively.

In FIGS. 3a and 3b it can be seen that the eye patterns of the data signals are jittery, in that the zero crossings are diffuse. Thus, even with bit synchronous sampling, the timing error ψₖ fluctuates. In FIG. 3b the eye pattern is closed at the central eye; thus ψₖ cannot be determined by means of the central eye in the eye pattern at a disc capacity of 32 GB and traditional threshold timing recovery is not feasible.

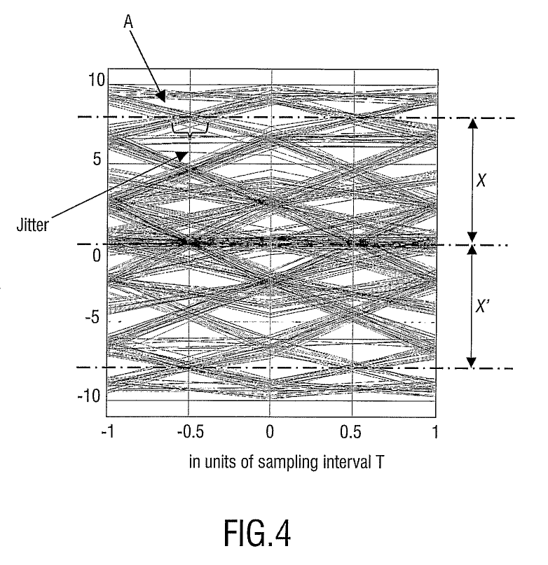

FIG. 4 illustrates threshold shifts in an eye pattern according to the invention. The eye pattern is equivalent the one shown in FIG. 3b, i.e. FIG. 4 is an eye pattern of a 32 GB Blu-ray disc. It can be seen, that even though the central eye is closed, upper and lower eyes remains substantially open. Therefore, it is feasible to use the upper and/or lower secondary eye to acquire the timing error ψₖ. This can be realized by shifting the threshold level, which was at the value zero up to x or down to x′, which are positioned at the horizontal axes of the upper and lower secondary eyes, respectively. If the channel is linear, it can be assumed that x′=−x. Accordingly, equation (3) is altered to the two equations:

$$\begin{matrix}\begin{matrix}{ψ}_{m} = \frac{{y}_{m} - x}{{y}_{m} - {y}_{m + 1}} - α T , & & & ( upper eye )\end{matrix} & ( 1 ) \\ and & \\ \begin{matrix}{ψ}_{m} = \frac{{y}_{m} - {x}^{′}}{{y}_{m} - {y}_{m + 1}} - β T , & & & ( lower eye )\end{matrix} & ( 2 )\end{matrix}$$

T is the data sample period, yₘ and yₘ₊₁, respectively, is the data signal sample at the instants mT and (m+1)T, respectively, α and β are a phase shift constants both lying in the interval [0; 1], and x and x′ are displacements of the value of the threshold. α and β indicate the phase, when the signal waveform crosses the level x or x′ with the bit synchronous sampling. It should be noted, that yₘ and yₘ₊₁ are samples around the new threshold crossing.

In FIG. 4 the arrow A indicates a crossing point of two single tone signal waveforms having the same period and 1 T phase difference, which determines the threshold shift x and the phase α. From FIG. 4 it can be seen that the jitter of the shifted threshold crossings is reduced substantially compared to the zero crossings, but still exists. Thus, α and β indicate the average phase, when threshold crossings appear. An example of the determination of α and β is described below, but a typical value is α=β=0.5 T.

### EXAMPLE

A data signal on a 32 GB Blu-ray disc encoded in RLL coding (d=1) (i.e. the minimum run length in the coding is d+1) is read and timing information is determined by use of the method of the invention. It is assumed, that the channel is linear and that the channel symbol response after equalization can be expressed as an FIR filter gₖ (k=0, ±1, . . . ±N), where N denotes the one-side expansion of the filter. Ideally, the filter possesses a symmetric shape.

In RLL (d=1) coding, the necessary conditions, that the threshold levels x and x′ (x≧0, x′=−x) must satisfy are the following:

$$\begin{matrix}\begin{matrix}Case 1 \text{:} & \vert {\sum }_{\vert k \vert \leq n} \vert {g}_{k} \vert - {\sum }_{\vert k \vert > n + 1} \vert {g}_{k} \vert \vert > x and \vert {\sum }_{\vert k \vert \leq n} \vert {g}_{k} \vert - {\sum }_{\vert k \vert > n} \vert {g}_{k} \vert \vert < x\end{matrix} & ( 4 ) \\ \begin{matrix}Case 2 \text{:} & \vert {\sum }_{\vert k \vert \leq n + 1} \vert {g}_{k} \vert - {\sum }_{\vert k \vert > n + 1} \vert {g}_{k} \vert \vert > x and \vert {\sum }_{\vert k \vert \leq n} \vert {g}_{k} \vert - {\sum }_{\vert k \vert > n + 1} \vert {g}_{k} \vert \vert < x\end{matrix} & ( 5 )\end{matrix}$$

where 0≦n<N−1 and case 1 should be used, when the shortest run length involved is an even number, while case 2 should be used, when the shortest run length involved is an odd number. If no value of “n” can make the equation (4) or (5) true, it is concluded that no open eye exists in the eye diagram around either x or x′=−x. Thus, the equations (4) and (5) can be computed for successive values of x to find the values of x, corresponding to secondary open eyes, if any.

Moreover, the shifted threshold level x must fulfill the condition that two sinusoidal waveforms of the same period (e.g. same run length) and with a phase shift 1 T cross each other at the threshold level x. In FIG. 4 such a waveform crossing is indicated by the arrow “A”.

The two conditions above must be fulfilled if a secondary open eye exists at a shifted threshold level: i.e. one of the equations (4) and (5) must be true for a threshold level x, and the threshold level x must be equal to a value (to the first order) where two sinusoidal waveforms of the same period and with a phase shift 1 T cross each other.

In the example in FIG. 4 (32 GB Blu-ray disc), the run lengths which are able to cross the threshold level x are at least 5. Run lengths shorter than 5 are invisible to the threshold timing recovery means. Hereby, the shorter run lengths (in this example the run lengths shorter than 5), which are most exposed to noise, do not contribute to the detection of the timing error ψₖ. Hereby, the data induced jitter is reduced significantly and the threshold timing recovery according to the invention is feasible for high capacity optical discs, for capacities where traditional timing recovery is unfeasible.

It should be noted that the initial position of the secondary eye can be pre-calculated according to knowledge of channel characteristics and/or can be determined based on experimental data. Moreover, the threshold shift levels can be adapted and/or adjusted during system running.

The values of α and β in equations (1) and (2) are determined by the phase of the point of the arrow “A”. In the example shown in FIG. 4, the phase shifts both equal the value 0.5 T.

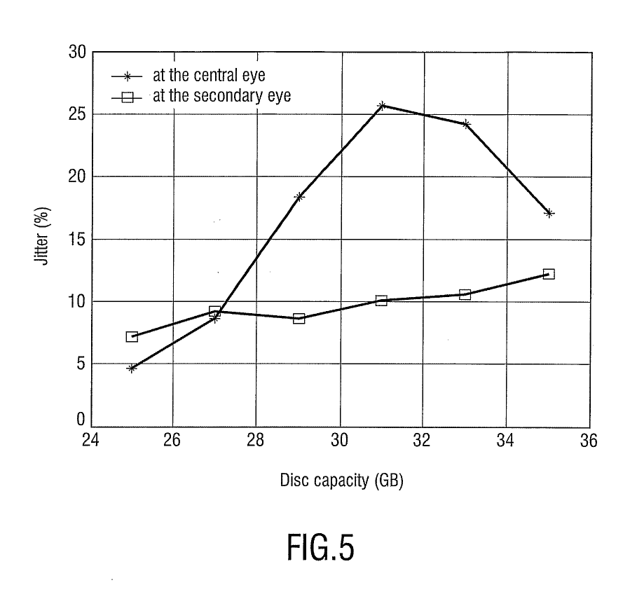

FIG. 5 shows jitter values measured at the central eye and at the secondary eye according to the invention for discs of different disc capacities. It can be seen that for disc capacities of 27 GB and below, the jitter is less prevailing at the central eye compared to the secondary eye. FIG. 5 moreover shows that the jitter at the central eye rises from around 5% at a disc capacity of 25 GB to more than 25% at a disc capacity of 31 GB. For capacities above 27 GB (up to at least 35 GB) the jitter is less prevailing at the secondary eye compared to at the central eye. The advantage of using the secondary eye compared to the central eye is most obvious at disc capacities between 29 and 33 GB, in that the jitter at the central eye and second eye, respectively, for these capacities lies at about 20% and at about 10%, respectively. Thus FIG. 5 substantiates that the method of providing threshold crossing timing recovery according to the invention, where timing error is extracted at the position of a secondary eye in the eye pattern, is less subject to jitter than traditional methods for high capacity optical discs and that it renders threshold crossing timing recovery possible for high capacity optical discs systems where the central eye in the eye diagram is nearly closed due to inter-symbol interference.

1. A method of providing threshold crossing timing recovery in an optical system, which optical system is adapted to read data signal samples (yₛ) from an optical disc, said method comprising the steps of:
reading data signal samples (yₛ) at a sampling time (tₛ) from the optical disc by means of the optical system,
feeding the read data signal samples (yₛ) to a timing recovery means (100) comprising a timing error detection means (20), determining timing error information (em) by means of the timing error detection means (20),
adjusting the sampling time (tₛ) towards synchronous timing instants (tₖ) on the basis of the timing error information (ψₖ), characterized in that an eye pattern of the data signal samples (yₛ) is used in the step of determining timing error information (ψₖ), and that the timing error detection means (20) is adapted to extract timing error information (ψₖ) at the position of a secondary eye in the eye pattern.

2. A method according to claim 1, characterized in that the timing recovery means uses threshold crossing timing recovery.

3. A method according to claim 2, characterized in that the threshold crossing timing recovery is zero crossing timing recovery.

4. A method according to claim 1, characterized in that the timing error information (ψₘ) around a threshold crossing between the instants mT and (m+1)T is calculated as:
$${ψ}_{m} = \frac{{y}_{m} - x}{{y}_{m} - {y}_{m + 1}} - α T ,$$
where T is the data sample period, yₘ and yₘ₊₁, respectively, is the data signal sample at the instants mT and (m+1)T, respectively, a is a phase shift constant lying in the interval 0≦α<1, and x is a displacement of the threshold.

5. A method according to claim 1, characterized in that the timing error information (ψₘ) around a threshold crossing between the instants mT and (m+1)T is calculated as:
$${ψ}_{m} = \frac{{y}_{m} - {x}^{′}}{{y}_{m} - {y}_{m + 1}} - β T ,$$
where T is the data sample period, yₘ and yₘ₊₁, respectively, is the data signal sample at the instants mT and (m+1)T, respectively, β is a phase shift constant lying in the interval 0≦β<1, and x′ is a displacement of the threshold.

6. A system for performing the method according to claim 1.

7. An apparatus for writing bit patterns on an optical disc to be read in by use of method according to claim 1.

8. A disc whereon bit patterns are written to be read by use of the method according to claim 1.
